(19) United States
(12) Patent Application Publication
(10) Pub. No.: US 2024/0364407 A1
(43) Pub. Date: Oct. 31, 2024

(54) LAYER 2 SIGNALING OF A COMPRESSED CHANNEL STATE INFORMATION REPORT

(71) Applicant: QUALCOMM Incorporated, San Diego, CA (US)

(72) Inventors: Abdelrahman Mohamed Ahmed Mohamed IBRAHIM, San Diego, CA (US); Renqiu WANG, San Diego, CA (US); Runxin WANG, San Diego, CA (US); Duo ZHANG, San Diego, CA (US); Taesang YOO, San Diego, CA (US); Pavan Kumar VITTHALADEVUNI, San Diego, CA (US); Jay Kumar SUNDARARAJAN, San Diego, CA (US)

(21) Appl. No.: 18/308,069

(22) Filed: Apr. 27, 2023

(51) Int. Cl. H04B 7/06

(52) U.S. Cl. CPC H04B 7/0658; H04B 7/0626; H04B 7/0632

(57) ABSTRACT

Various aspects of the present disclosure generally relate to wireless communication. In some aspects, a user equipment (UE) may receive one or more channel state information (CSI) reference signals (CSI-RSs). The UE may transmit a compressed CSI report via layer 2 signaling, the compressed CSI report being compressed using a machine learning model. Numerous other aspects are described.

### FIELD OF THE DISCLOSURE

Aspects of the present disclosure generally relate to wireless communication and to techniques and apparatuses for layer 2 signaling of a compressed channel state information report.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include receiving one or more channel state information (CSI) reference signals (CSI-RSs). The method may include transmitting a compressed CSI report via layer 2 (L2) signaling, the compressed CSI report being compressed using a machine learning model.

Some aspects described herein relate to a method of wireless communication performed by a network node. The method may include transmitting one or more CSI-RSs. The method may include receiving a compressed CSI report via L2 signaling, the compressed CSI report being compressed using a machine learning model.

Some aspects described herein relate to a UE for wireless communication. The UE may include a memory and one or more processors coupled to the memory. The one or more processors may be configured to receive one or more CSI-RSs. The one or more processors may be configured to transmit a compressed CSI report via L2 signaling, the compressed CSI report being compressed using a machine learning model.

Some aspects described herein relate to a network node for wireless communication. The network node may include a memory and one or more processors coupled to the memory. The one or more processors may be configured to transmit one or more CSI-RSs. The one or more processors may be configured to receive a compressed CSI report via L2 signaling, the compressed CSI report being compressed using a machine learning model.

Some aspects described herein relate to a non-transitory computer-readable medium that stores a set of instructions for wireless communication by a UE. The set of instructions, when executed by one or more processors of the UE, may cause the UE to receive one or more CSI-RSs. The set of instructions, when executed by one or more processors of the UE, may cause the UE to transmit a compressed CSI report via L2 signaling, the compressed CSI report being compressed using a machine learning model.

Some aspects described herein relate to a non-transitory computer-readable medium that stores a set of instructions for wireless communication by a network node. The set of instructions, when executed by one or more processors of the network node, may cause the network node to transmit one or more CSI-RSs. The set of instructions, when executed by one or more processors of the network node, may cause the network node to receive a compressed CSI report via L2 signaling, the compressed CSI report being compressed using a machine learning model.

Some aspects described herein relate to an apparatus for wireless communication. The apparatus may include means for receiving one or more CSI-RSs. The apparatus may include means for transmitting a compressed CSI report via L2 signaling, the compressed CSI report being compressed using a machine learning model.

Some aspects described herein relate to an apparatus for wireless communication. The apparatus may include means for transmitting one or more CSI-RSs. The apparatus may include means for receiving a compressed CSI report via L2 signaling, the compressed CSI report being compressed using a machine learning model.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of an example associated with compression of a precoder associated with a channel estimate, in accordance with the present disclosure.

FIG. 5 is a diagram of an example associated with layer 2 (L2 ) signaling of a compressed channel state information (CSI) report, in accordance with the present disclosure.

FIG. 6 is a diagram of an example associated with compression of an L2 CSI report associated with a channel estimate, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In some networks, a network node may transmit, and a user equipment (UE) may receive, channel state information (CSI) reference signals (CSI-RSs) for the UE to use to measure channel metrics and/or estimate a channel. The UE may transmit a CSI report to indicate the channel metrics and/or channel estimation to the network node, which the network node may use to identify communication parameters for communicating with the UE.

In beamforming-based communications and/or for communications using relatively high frequency ranges (e.g., frequency ranges that are higher than 2 GHz, sub-6 GHz frequency ranges, or sub-THz frequency ranges, among other examples), channel metrics may change more frequently than for relatively low frequency ranges. Additionally, or alternatively, a channel may change more frequently than for low frequency ranges or omnidirectional communications. For example, higher frequency communications may have narrower beams, which may correspond to rapid changes in channel metrics or a channel estimate with UE movement or changes to an environment.

To account for rapid changes in channel metrics or a channel estimate, CSI-RSs may be transmitted with a shorter periodicity, the UE may transmit CSI reports with a shorted periodicity, and/or content of the CSI report may include additional information. However, each of these may result in consumption of network resources that may have otherwise been used to increase an amount of data communicated between the network node and the UE.

Various aspects relate generally to layer 2 (L2 ) signaling of a compressed CSI report. Some aspects more specifically relate to a UE transmitting compressed L2 signaling (e.g., a CSI report) via a medium access control (MAC) control element (CE). In some examples, the MAC CE may indicate an encoder output (e.g., a compressed representation of a precoder calculated based at least in part on CSI-RS measurements and/or a channel estimate), an indication of a channel quality indicator (CQI) and/or rank index (RI) (e.g., for a wideband or for subbands of the wideband), an indication of a machine learning model used to compress (e.g., encode) CSI (e.g., a precoder), and/or timing information that indicates which CSI-RS resource is associated with the CSI, among other examples.

In some aspects, the UE may transmit the compressed CSI periodically or semi-persistently (e.g., when activated). The compressed CSI report may be automatically activated when the CSI-RSs are activated or configured. Alternatively, the CSI report may be activated independently from activation or configuration of the CSI-RSs.

Particular aspects of the subject matter described in this disclosure can be implemented to realize one or more of the following potential advantages. In some examples, by a UE providing a CSI report as a compressed CSI report via L2 signaling, the described techniques can be used to conserve communication resources that may have otherwise been used to transmit an uncompressed CSI report via L1 signaling. Additionally, or alternatively, based at least in part on conserving the communication resources, the UE may provide the compressed CSI report with a shorter periodicity, which may support additional updates to communication parameters, which may improve spectral efficiency and/or reduce error rates.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

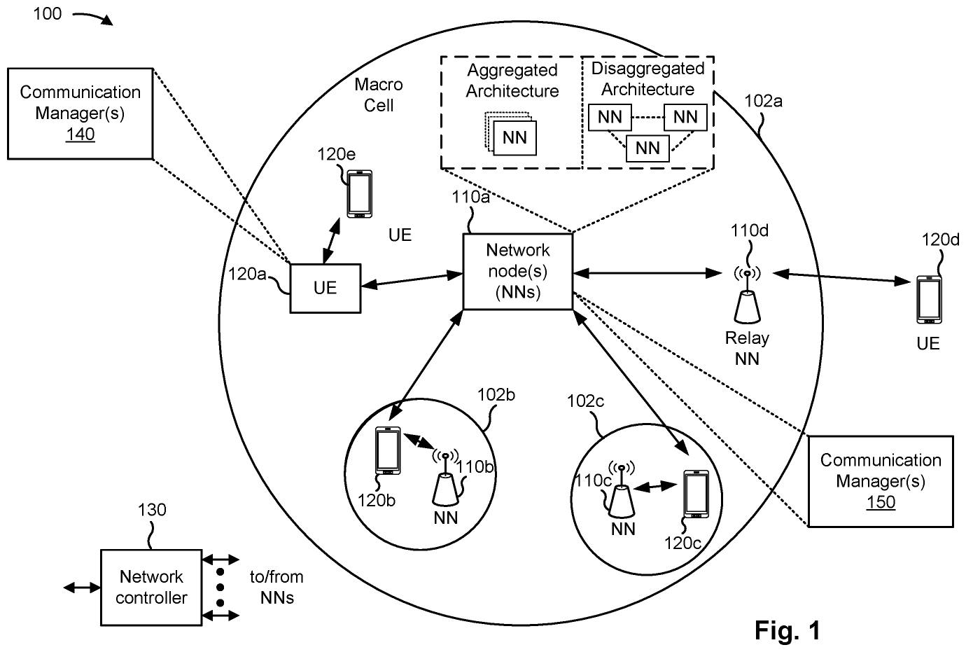

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network clement, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC. or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive one or more CSI-RSs; and transmit a compressed CSI report via L2 signaling, the compressed CSI report being compressed using a machine learning model. Additionally, or alternatively, the communication manager 140 may perform one or more other operations described herein.

In some aspects, the network node 110 may include a communication manager 150. As described in more detail elsewhere herein, the communication manager 150 may transmit one or more CSI-RSs; and receive a compressed CSI report via L2 signaling, the compressed CSI report being compressed using a machine learning model. Additionally, or alternatively, the communication manager 150 may perform one or more other operations described herein.

As indicated above, FIG. 1 is provided as an example. Other examples may differ from what is described with regard to FIG. 1.

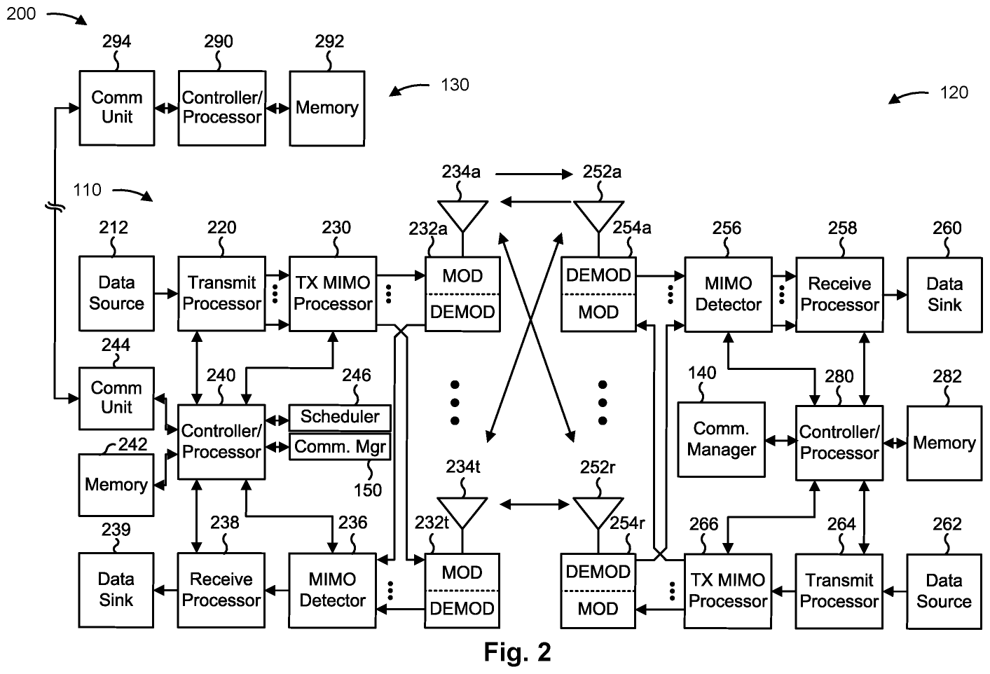

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and May provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

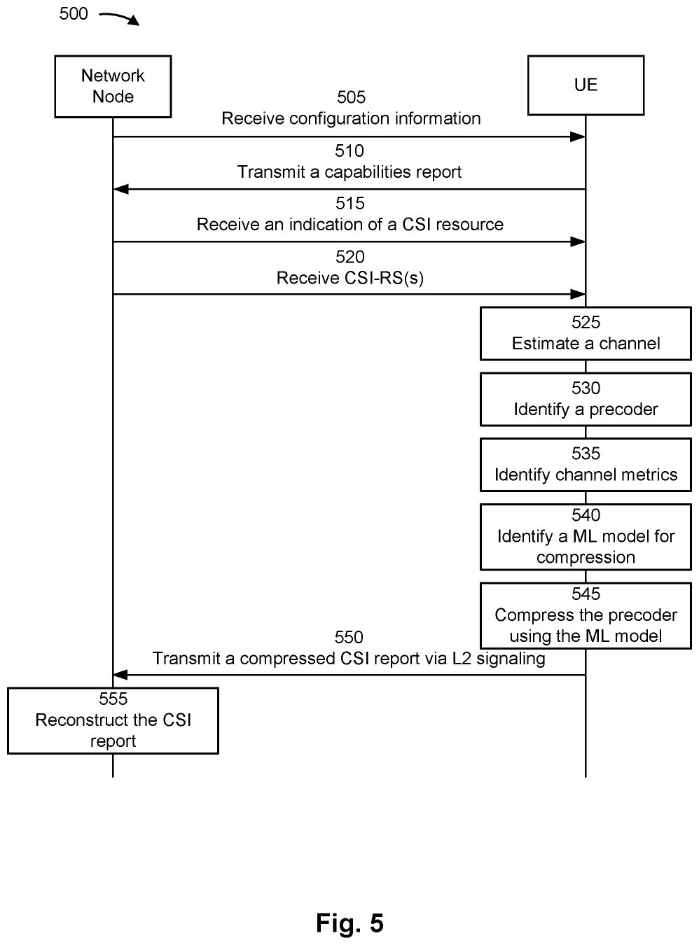

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

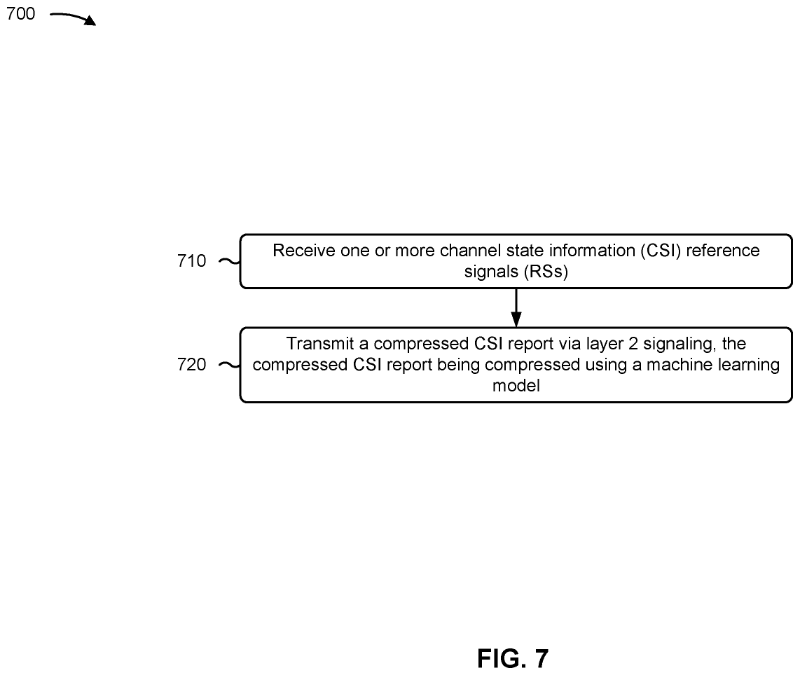

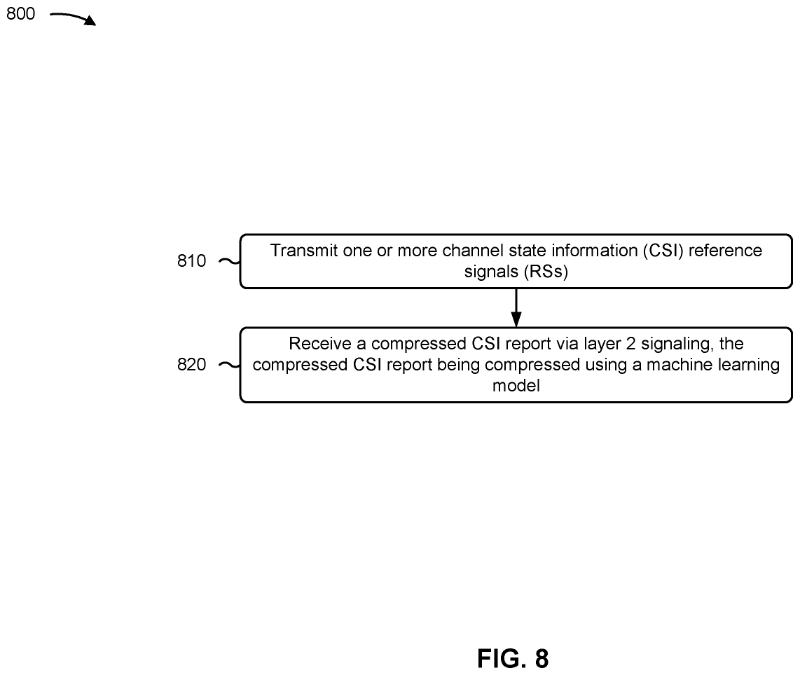

The controller/processor 240 of the network node 110, the controller/processor 280 of the UE 120, and/or any other component(s) of FIG. 2 may perform one or more techniques associated with L2 signaling of a compressed CSI report, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving one or more CSI-RSs; and/or means for transmitting a compressed CSI report via L2 signaling, the compressed CSI report being compressed using a machine learning model. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting one or more CSI-RSs; and/or means for receiving a compressed CSI report via L2 signaling, the compressed CSI report being compressed using a machine learning model. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware. software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (NB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

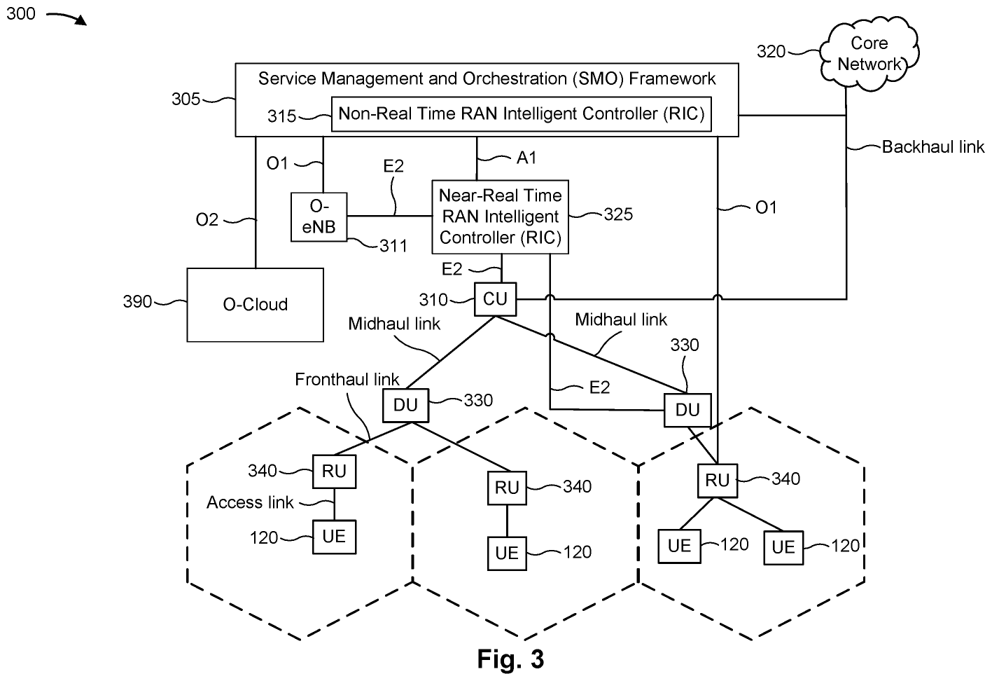

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

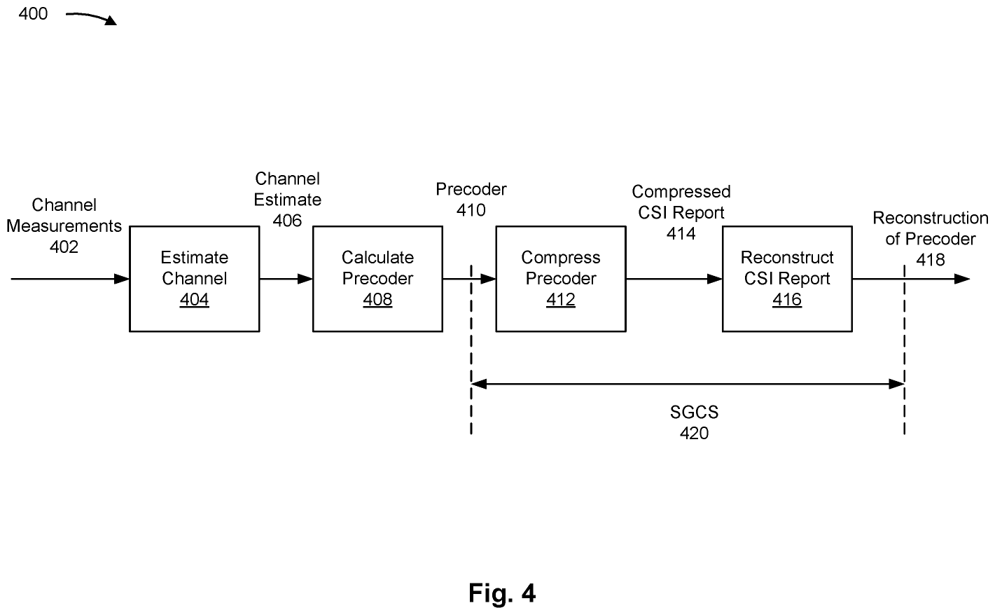

FIG. 4 is a diagram of an example 400 associated with compression of a precoder associated with a channel estimate, in accordance with the present disclosure. In the context of FIG. 4, a UE (e.g., UE 120) may communicate with a network node (e.g., network node 110) via a wireless network (e.g., wireless network 100.

As shown in FIG. 4, a UE may obtain channel measurements 402. For example, the UE may obtain the channel measurements 402 based at least in part on measuring one or more CSI-RSs. As shown by reference number 404, the UE may estimate a channel associated with the channel measurements 402. For example, the UE may obtain a channel estimate that is represented as a matrix with entries associated with reception parameters for different frequencies and/or times as measured from the one or more CSI-RSs.

As shown in FIG. 4, the UE may generate a channel estimate 406 based at least in part on estimating a channel. As shown by reference number 408, the UE may calculate a precoder associated with the channel estimate 406. For example, the UE may perform singular value decomposition (SVD) using the channel estimate to obtain the precoder.

The UE may generate a precoder 410 as an input to an encoder based at least in part on calculating the precoder. As shown by reference number 412, the UE may compress the precoder. In some examples, the UE may use a machine learning model to compress the precoder 410. For example, the UE may use a neural network to compress the precoder.

The UE may transmit a compressed CSI report 414 (e.g., a machine-learning-based CSI report) to a network node. As shown by reference number 416, the network node may reconstruct the CSI report. Based at least in part on reconstructing the CSI report, the UE may generate a reconstruction of the precoder.

The reconstruction of the precoder 418 may have errors relative to the precoder 410 based at least in part on compression and reconstruction processes. In some examples, the network node may transmit an indication of error, such as a squared generalized cosine similarity (SGCS) 420, to the UE.

As indicated above, FIG. 4 is provided as an example. Other examples may differ from what is described with regard to FIG. 4.

Using compression and reconstruction of the CSI to communicate a CSI report may improve an amount of overhead consumed in a reporting procedure. However, layer 1 signaling (e.g., uplink control information (UCI)) may not support a payload of a compressed precoder and/or other CSI. Additionally, or alternatively, layer 1 signaling may not provide flexibility of a payload of the CSI report.

Various aspects relate generally to L2 signaling of a compressed CSI report. Some aspects more specifically relate to a UE transmitting the compressed L2 signaling via a MAC CE. In some examples, the MAC CE may indicate an encoder output (e.g., a compressed representation of a precoder calculated based at least in part on CSI-RS measurements and/or a channel estimate), an indication of a CQI and/or RI (e.g., for a wideband or for subbands of the wideband), an indication of a machine learning model used to compress (e.g., encode) CSI (e.g., a precoder), and/or timing information that indicates which CSI-RS resource is associated with the CSI, among other examples.

In some aspects, the UE may use a MAC CE (e.g., L2 MAC CE) for feedback of compressed CSI. The MAC CE may include various fields of information. For example, the MAC CE may indicate an encoder output (e.g., encoder output z). The encoder output may include a compressed representation of precoder vector Vin. The encoder output may be organized into N×L blocks, where N is a number of subbands associated with measured CSI-RSs and L is a number of layers. Each block may represent a compressed precoder for one CSI subband at one layer. In some aspects, the blocks may be ordered according to layer indexes or subband indexes.

The MAC CE may include indications of wideband or subband CQI and/or RI. For example, the MAC CE may include the RI and/or CQI that is calculated based at least in part on an uncompressed precoder and/or a CSI reconstruction error and an associated impact on spectral efficiency. For example, CQI may be based at least in part on a reconstructed precoder (e.g., where a CSI encoder at the UE is different from a network node decoder). In some aspects, CQI information may be associated with a wideband representation of the channel or subbands of the channel. In some aspects, a number of subbands indicated for CQI may be the same or smaller than a number of subbands indicated within the compressed precoder. For example, the UE may use N precoder subbands and N/2 CQI subbands.

The MAC CE may include indications of which neural network model is used for CSI compression. For example, the MAC CE may indicate a neural network model ID. The MAC CE may indicate the neural network model ID from a set of configured neural networks available to the UE. Based at least in part on providing an indication of a network node used to compress the CSI, the UE may have flexibility to select a neural network that is most efficient, instead of using only one possible neural network.

The MAC CE may include timing information associated with one or more CSI-RS resources that were used to obtain CSI. The timing information may be used by the network node to determine whether CSI feedback is based on a latest CSI-RS transmission or not. In some aspects, the timing information may include a slot and/or subframe number (SFN) of the one or more CSI-RS resources used for generating the CSI. In some aspects, the MAC CE may indicate additional timing information related to a whole CSI timeline. The UE may use the additional timing information to identify the CSI-RSs in case of queued CSI at the UE based at least in part on delayed physical uplink shared channel (PUSCH) grants. In some aspects, the MAC CE may indicate a slot of SFN of a first CSI-RS used for CSI generation once L2 feedback for CSI feedback is activated. Based at least in part on providing an indication of a CSI-RS resource used to obtain the CSI, the network node may map the CSI to CSI-RSs, which may improve selection of communication parameters by the network node.

In some aspects, the CSI report may be periodic or semi-persistent. The UE may be configured to activate the CSI report based at least in part on associated CSI-RSs being configured or activated (e.g., semi-persistent CSI-RSs). In this way, overhead may be reduced, which may have otherwise been used to send activation or configuration information for each of the CSI-RSs and the CSI report. Alternatively, the UE may be configured to receive activation or configuration of the CSI report separately from activation or configuration of the associated CSI-RSs. In this way, the CSI report may not always be active when receiving the CSI-RSs, which may conserve communication, power, network, and/or computing resources that may have otherwise been used to transmit the CSI report when not desired by the network node.

FIG. 5 is a diagram of an example 500 associated with L2 signaling of a compressed CSI report, in accordance with the present disclosure. As shown in FIG. 5, a network node (e.g., network node 110, a CU, a DU, and/or an RU) may communicate with a UE (e.g., UE 120). In some aspects, the network node and the UE may be part of a wireless network (e.g., wireless network 100). The UE and the network node may have established a wireless connection prior to operations shown in FIG. 5.

As shown by reference number 505, the network node may transmit, and the UE may receive, configuration information. In some aspects, the UE may receive the configuration information via one or more of radio resource control (RRC) signaling, one or more MAC CEs, and/or downlink control information (DCI), among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to use L2 signaling to transmit a CSI report. In some aspects, the configuration information may indicate that the UE is to compress CSI reports using a machine learning model, such as a neural network. In some aspects, the machine learning model may be associated with an additional neural network at the network node that is configured to reconstruct information compressed by the neural network at the UE. In some aspects, the configuration information may indicate that the UE is to activate or configure resources for a CSI report based at least in part on activation or configuration of a CSI-RS resource. Alternatively, the UE configuration information may indicate that the UE is to activate or configure resources for a CSI report based at least in part on an indication that is separate from an indication to activate associated CSI-RS resources.

The UE may configure itself based at least in part on the configuration information. In some aspects, the UE may be configured to perform one or more operations described herein based at least in part on the configuration information.

As shown by reference number 510, the UE may transmit, and the network node may receive, a capabilities report. In some aspects, the capabilities report may indicate UE support for compressing an L2 CSI report. In some aspects, the UE may indicate supported neural networks or other machine learning models that the UE can use to compress the CSI report and/or information within the CSI report.

As shown by reference number 515, the UE may receive, and the network node may transmit, an indication of a CSI resource to use for reception of one or more CSIs. In some aspects, the CSI resource may be a dynamic resource, a semi-persistent (e.g., activated) resource, or a periodic (e.g., configured) resource, among other examples.

As shown by reference number 520, the UE may receive, and the network node may transmit, one or more CSI-RSs. The one or more CSI-RSs may be associated with the CSI resource indicated in connection with reference number 515. In some aspects, the UE may receive the CSI-RSs as dynamically scheduled CSI-RSs, periodic CSI-RSs, or semi-persistent CSI-RSs.

As shown by reference number 525, the UE may estimate a channel. For example, the UE may estimate a channel for communications with the network node based at least in part on measurements of the one or more CSI-RSs.

As shown by reference number 530, the UE may identify a precoder associated with communications with the network node. For example, the precoder may be based at least in part on a channel estimate and/or measurements of the one or more CSI-RSs.

As shown by reference number 535, the UE may identify one or more channel metrics. For example, the UE may identify CQI and/or RI to indicate to the network node within a CSI report along with the precoder. In some aspects, the CQI and/or the RI may be based at least in part on an estimation of reconstruction of the compressed CSI report by the network node. For example, the UE may estimate an output of a machine learning (ML) model of the network node, where the ML model of the network node is configured to reconstruct the CSI report. In some aspects, the UE may perform a reconstruction procedure on an output of a UE ML model used to compress the CSI report to generate an estimation of reconstruction of the compressed CSI report. For example, the UE may compress one or more portions of the CSI report (e.g., the precoder) using a ML model (e.g., described in connection with reference number 545) and then reconstruct the CSI report using an additional ML model to generate the estimate of the reconstruction of the compressed CSI report by the network node. In some aspects, the additional ML model may be based at least in part on an ML model to be used by the network node to reconstruct the CSI report.

In some aspects, the CQI includes quality information for a wideband frequency band or subbands of the wideband frequency band. For example, the CQI may be indicated for the entire band associated with the CSI-RSs or may be indicated with a granularity of subbands. In some aspects, the number of subbands is less than or equal to a number of subbands associated with an encoder output (e.g., a compressed precoder using a ML model described in connection with reference number 545).

As shown by reference number 540, the UE may identify an ML model for compression. For example, the UE may identify the ML model from a set of candidate ML models. In some aspects, the UE may select the ML model autonomously or may receive an indication to use the ML model from the network node, among other examples. In some aspects, the ML model may be a first ML model and associated with a a second ML model at the network node. In some aspects, association of the first ML model with the second ML model supports reconstruction of compressed information by the network node using the seconde ML model.

As shown by reference number 545, the UE may compress the precoder using the ML model. For example, the UE may provide the precoder as an input to the ML model (e.g., a neural network) to compress the precoder. Based at least in part on the precoder being compressed, the precoder may be indicated with a reduced number of bits.

In some aspects, an encoder output includes a set of blocks of information, the set of blocks of information having a quantity that is based at least in part on a number of subbands and a number of layers associated with the one or more CSI-RSs. In some aspects, each block of the set of blocks of information is associated with a compressed precoder for one CSI subband on one layer. The set of blocks may be ordered (e.g., organized in sequential order) based at least in part on respective layer identifiers and/or subband identifiers. For example, first blocks may all be associated with a first layer identifier, second blocks may all be associated with a second layer identifier, etc. Alternatively, first blocks may all be associated with a first subband identifier, second blocks may all be associated with a second subband identifier, etc.

As shown by reference number 550, the UE may transmit, and the network node may receive, a compressed CSI report via L2 signaling. For example, the UE may transmit the compressed CSI report via a MAC CE. In some aspects, the compressed CSI report may be a compressed CSI report based at least in part on including information that is compressed using the ML model.

In some aspects, the compressed CSI report may include an encoder output that indicates a precoder associated with receiving the one or more CSI-RSs, a CQI, an RI, an indication of the ML model, and/or an indication of one or more CSI-RS occasions associated with the compressed CSI report, among other examples. In some aspects, the encoder output may indicate precoders for one or more subbands of the channel or for a wideband precoder for the entire channel. In some aspects, a number of the one or more subbands may be greater than or equal to a number of subbands indicated with CQI.

In some aspects, the indication of the ML model may include an ML model identifier that identifies the ML model from a set of candidate ML models that could be used to compress the precoder.

In some aspects, the indication of one or more CSI-RS occasions associated with the compressed CSI report includes an indication of a slot and subframe number of a CSI-RS occasion associated with the compressed CSI report. In some aspects, the indication of one or more CSI-RS occasions associated with the compressed CSI report includes an indication of a slot and subframe number of a first CSI-RS occasion used to generate the compressed CSI report after CSI reports are activated. In this way, the UE may not consume resources to indicate each CSI resource associated with each CSI report.

In some aspects, the UE may transmit the compressed CSI report as a periodic or semi-persistent compressed CSI report using periodic resources that are activated or configured. In some aspects, the compressed CSI report may be activated or configured based at least in part on activation or configuration of periodic or semi-persistent CSI-RSs that are to be measured to generate the CSI report. Alternatively, the compressed CSI report may be activated via an activation indication that is separate from an activation or configuration of periodic or semi-persistent CSI-RSs. In some aspects, an activation indication may indicate one or more L2 CSI reports to activate or deactivate.

As shown by reference number 555, the network node may reconstruct the precoder that is compressed by the UE. For example, the network node may reconstruct the precoder and/or one or more additional portions of the compressed CSI report to generate a reconstructed CSI report. The reconstructed CSI report may be similar to contents of the CSI report before compression. In some aspects, the reconstructed CSI report may have an error relative to the CSI report before compression (e.g., SGCS). The network node may use the reconstructed precoder to identify one or more communication parameters for communication with the UE.

Based at least in part on the UE providing a CSI report as a compressed CSI report via L2 signaling, the described techniques can be used to conserve communication resources that may have otherwise been used to transmit an uncompressed CSI report via L1 signaling. Additionally, or alternatively, based at least in part on conserving the communication resources, the UE may provide the compressed CSI report with a smaller periodicity, which may support additional updates to communication parameters, which may improve spectral efficiency and/or reduce error rates.

As indicated above, FIG. 5 is provided as an example. Other examples may differ from what is described with respect to FIG. 5.

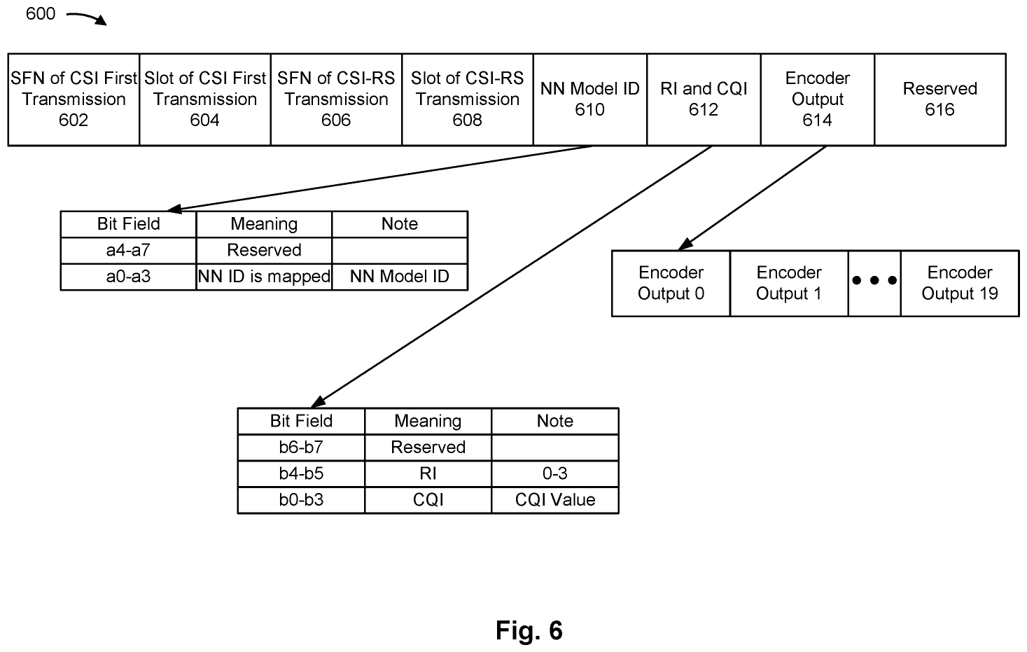

FIG. 6 is a diagram of an example 600 associated with compression of an L2 CSI report associated with a channel estimate, in accordance with the present disclosure. In the context of FIG. 6, a UE (e.g., UE 120) may communicate with a network node (e.g., network node 110) via a wireless network (e.g., wireless network 100.

As shown in FIG. 6, a compressed L2 CSI report may include one or more fields that indicate CSI to a network node from a UE. A first field 602 may indicate an SFN of a CSI first transmission that is associated with the compressed L2 CSI report. A second field 604 may indicate a slot of the CSI first transmission. In some aspects, the first field 602 and the second field 604 may be associated with a first CSI-RS resources used for CSI generation in a current session. In some aspects, the first field 602 and the second field 604 may be used to indicate an SFN and/or a slot of a first CSI report of the current session. In this way, the network node may identify a first CSI resource that is associated with information provided within the CSI report.

A third field 606 may indicate an SFN of a CSI-RS first transmission that is associated with the compressed L2 CSI report. A fourth field 608 may indicate a slot of the CSI first transmission. In some aspects, the fourth field 608 may be associated with a last (e.g., most-recent) CSI-RS resource that is used for generating the CSI of the L2 CSI report. In this way, the network node may identify a last CSI-RS resource that is associated with information provided within the CSI report.

A fifth field 610 may indicate a neural network ID. In some aspects, one or more of the bitfields of the fifth field 610 may include reserved bits, and other bitfields may be used to indicate the neural network ID. The fifth field 610 may include a bitmap to candidate ML models or may indicate a codepoint of the ML model.

A sixth field 612 may indicate RI and CQI. In some aspects, one or more of the bitfields of the sixth field 612 may include reserved bits, an indication of an RI, and/or an indication of a CQI value.

A seventh field 614 may include an encoder output. The encoder output may include multiple outputs. The multiple outputs may be associated with different layers and/or different subbands.

An eighth field 616 may include reserved bits.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with L2 signaling of a compressed channel.

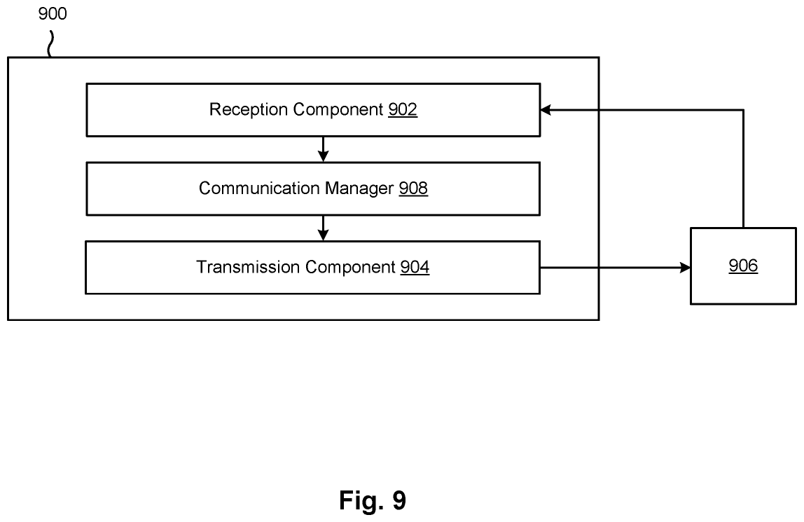

As shown in FIG. 7, in some aspects, process 700 may include receiving one or more CSI-RSs (block 710). For example, the UE (e.g., using reception component 902 and/or communication manager 906, depicted in FIG. 9) may receive one or more CSI-RSs, as described above.

As further shown in FIG. 7, in some aspects, process 700 may include

transmitting a compressed CSI report via L2 signaling, the compressed CSI report being compressed using a machine learning model (block 720). For example, the UE (e.g., using transmission component 904 and/or communication manager 906, depicted in FIG. 9) may transmit a compressed CSI report via L2 signaling, the compressed CSI report being compressed using a machine learning model, as described above.

Process 700 may include additional aspects, such as any single aspect or any combination of aspects described below and/or in connection with one or more other processes described elsewhere herein.

In a first aspect, the machine learning model is associated with an additional machine learning model at a network node, and association of the additional machine learning model to the machine learning model supports reconstruction of the compressed CSI report.

In a second aspect, alone or in combination with the first aspect, the compressed CSI report comprises one or more of an encoder output that indicates a precoder associated with receiving the one or more CSI-RSs, a CQI, a rank index (RI), an indication of the machine learning model, or an indication of one or more CSI-RS occasions associated with the compressed CSI report.

In a third aspect, alone or in combination with one or more of the first and second aspects, the encoder output comprises a set of blocks of information, the set of blocks of information having a quantity that is based at least in part on a number of subbands and a number of layers associated with the one or more CSI-RSs, and each block of the set of blocks of information is associated with a compressed precoder for one CSI subband on one layer.

In a fourth aspect, alone or in combination with one or more of the first through third aspects, the encoder output comprises the set of blocks ordered based at least in part on a layer identifier, or a subband identifier.

In a fifth aspect, alone or in combination with one or more of the first through fourth aspects, one or more of the CQI or the RI is associated with an estimation of reconstruction of the compressed CSI report.

In a sixth aspect, alone or in combination with one or more of the first through fifth aspects, the CQI includes quality information for one or more of a wideband frequency band, or subbands of the wideband frequency band.

In a seventh aspect, alone or in combination with one or more of the first through sixth aspects, a number of subbands of the wideband frequency band is less than or equal to a number of subbands indicated with the encoder output.

In an eighth aspect, alone or in combination with one or more of the first through seventh aspects, the indication of the machine learning model comprises an indication of the machine learning model from a set of candidate machine learning models.

In a ninth aspect, alone or in combination with one or more of the first through eighth aspects, the indication of one or more CSI-RS occasions associated with the compressed CSI report comprises one or more of an indication of a slot and subframe number of a CSI-RS occasion associated with the compressed CSI report, or an indication of a slot and subframe number of a first CSI-RS occasion used to generate the compressed CSI report after CSI reports are activated.

In a tenth aspect, alone or in combination with one or more of the first through ninth aspects, the compressed CSI report is a periodic or semi-persistent compressed CSI report.

In an eleventh aspect, alone or in combination with one or more of the first through tenth aspects, the compressed CSI report is activated based at least in part on activation or configuration of periodic or semi-persistent CSI-RSs.

In a twelfth aspect, alone or in combination with one or more of the first through eleventh aspects, the compressed CSI report is activated via an activation indication that is separate from an activation or configuration of periodic or semi-persistent CSI-RSs.

In a thirteenth aspect, alone or in combination with one or more of the first through twelfth aspects, the activation indication indicates one or more L2 CSI reports to activate or deactivate.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with L2 signaling of a compressed channel.

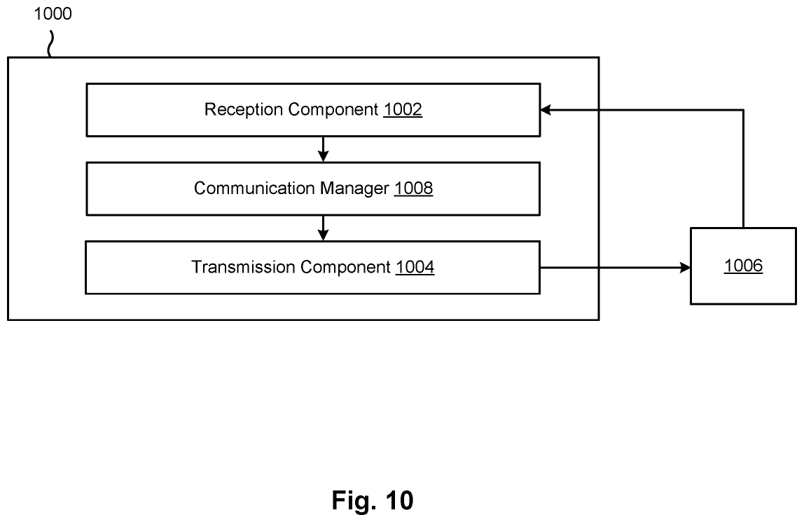

As shown in FIG. 8, in some aspects, process 800 may include transmitting one or more CSI-RSs (block 810). For example, the network node (e.g., using transmission component 1004 and/or communication manager 1006, depicted in FIG. 10) may transmit one or more CSI-RSs, as described above.

As further shown in FIG. 8, in some aspects, process 800 may include receiving a compressed CSI report via L2 signaling, the compressed CSI report being compressed using a machine learning model (block 820). For example, the network node (e.g., using reception component 1002 and/or communication manager 1006, depicted in FIG. 10) may receive a compressed CSI report via L2 signaling, the compressed CSI report being compressed using a machine learning model, as described above.

Process 800 may include additional aspects, such as any single aspect or any combination of aspects described below and/or in connection with one or more other processes described elsewhere herein.

In a first aspect, the machine learning model is associated with an additional machine learning model at the network node, and association of the additional machine learning model to the machine learning model supports reconstruction of the compressed CSI report.

In a second aspect, alone or in combination with the first aspect, the compressed CSI report comprises one or more of an encoder output that indicates a precoder associated with the one or more CSI-RSs, a CQI, an RI, an indication of the machine learning model, or an indication of one or more CSI-RS occasions associated with the compressed CSI report.

In a third aspect, alone or in combination with one or more of the first and second aspects, the encoder output comprises a set of blocks of information, the set of blocks of information having a quantity that is based at least in part on a number of subbands and a number of layers associated with the one or more CSI-RSs, and each block of the set of blocks of information is associated with a compressed precoder for one CSI subband on one layer.

In a fourth aspect, alone or in combination with one or more of the first through third aspects, the encoder output comprises the set of blocks ordered based at least in part on a layer identifier, or a subband identifier.

In a fifth aspect, alone or in combination with one or more of the first through fourth aspects, one or more of the CQI or the RI is associated with an estimation of reconstruction of the compressed CSI report.

In a sixth aspect, alone or in combination with one or more of the first through fifth aspects, the CQI includes quality information for one or more of a wideband frequency band, or subbands of the wideband frequency band.

In a seventh aspect, alone or in combination with one or more of the first through sixth aspects, a number of subbands of the wideband frequency band is less than or equal to a number of subbands indicated with the encoder output.

In an eighth aspect, alone or in combination with one or more of the first through seventh aspects, the indication of the machine learning model comprises an indication of the machine learning model from a set of candidate machine learning models.

In a ninth aspect, alone or in combination with one or more of the first through eighth aspects, the indication of one or more CSI-RS occasions associated with the compressed CSI report comprises one or more of an indication of a slot and subframe number of a CSI-RS occasion associated with the compressed CSI report, or an indication of a slot and subframe number of a first CSI-RS occasion used to generate the compressed CSI report after CSI reports are activated.

In a tenth aspect, alone or in combination with one or more of the first through ninth aspects, the compressed CSI report is a periodic or semi-persistent compressed CSI report.

In an eleventh aspect, alone or in combination with one or more of the first through tenth aspects, the compressed CSI report is activated based at least in part on activation or configuration of periodic or semi-persistent CSI-RSs.

In a twelfth aspect, alone or in combination with one or more of the first through eleventh aspects, the compressed CSI report is activated via an activation indication that is separate from an activation or configuration of periodic or semi-persistent CSI-RSs.

In a thirteenth aspect, alone or in combination with one or more of the first through twelfth aspects, the activation indication indicates one or more L2 CSI reports to activate or deactivate.

In a fourteenth aspect, alone or in combination with one or more of the first through thirteenth aspects, process 800 includes reconstructing the compressed CSI report to produce a reconstruction of a precoder.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive one or more CSI-RSs. The transmission component 904 may transmit a compressed CSI report via L2 signaling, the compressed CSI report being compressed using a machine learning model.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit one or more CSI-RSs. The reception component 1002 may receive a compressed CSI report via L2 signaling, the compressed CSI report being compressed using a machine learning model.

The communication manager 1006 may reconstruct the compressed CSI report to produce a reconstruction of a precoder.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving one or more channel state information (CSI)-reference signals (RSs); and transmitting a compressed CSI report via layer 2 signaling, the compressed CSI report being compressed using a machine learning model.

Aspect 2: The method of Aspect 1, wherein the machine learning model comprises a first machine learning model, wherein the machine learning model is associated with a second machine learning model at a network node, and wherein association of the second machine learning model to the machine learning model supports reconstruction of the compressed CSI report.

Aspect 3: The method of any of Aspects 1-2, wherein the compressed CSI report comprises one or more of: an encoder output that indicates a precoder associated with receiving the one or more CSI-RSs, a channel quality indicator (CQI), a rank index (RI), an indication of the machine learning model, or an indication of one or more CSI-RS occasions associated with the compressed CSI report.

Aspect 4: The method of Aspect 3, wherein the encoder output comprises a set of blocks of information, the set of blocks of information having a quantity that is based at least in part on a number of subbands and a number of layers associated with the one or more CSI-RSs, and wherein each block of the set of blocks of information is associated with a compressed precoder for one CSI subband on one layer.

Aspect 5: The method of Aspect 4, wherein the encoder output comprises the set of blocks ordered based at least in part on: a layer identifier, or a subband identifier.

Aspect 6: The method of Aspect 3, wherein one or more of the CQI or the RI is associated with an estimation of reconstruction of the compressed CSI report.

Aspect 7: The method of Aspect 3, wherein the CQI includes quality information for one or more of: a wideband frequency band, or subbands of the wideband frequency band.

Aspect 8: The method of Aspect 7, wherein a number of subbands of the wideband frequency band is less than or equal to a number of subbands indicated with the encoder output.

Aspect 9: The method of Aspect 3, wherein the indication of the machine learning model comprises an indication of the machine learning model from a set of candidate machine learning models.

Aspect 10: The method of Aspect 3, wherein the indication of one or more CSI-RS occasions associated with the compressed CSI report comprises one or more of: an indication of a slot and subframe number of a CSI-RS occasion associated with the compressed CSI report, or an indication of a slot and subframe number of a first CSI-RS occasion used to generate the compressed CSI report after CSI reports are activated.

Aspect 11: The method of any of Aspects 1-10, wherein the compressed CSI report is a periodic or semi-persistent compressed CSI report.

Aspect 12: The method of Aspect 11, wherein the compressed CSI report is activated based at least in part on activation or configuration of periodic or semi-persistent CSI-RSs.

Aspect 13: The method of Aspect 11, wherein the compressed CSI report is activated via an activation indication that is separate from an activation or configuration of periodic or semi-persistent CSI-RSs.

Aspect 14: The method of Aspect 13, wherein the activation indication indicates one or more layer 2 CSI reports to activate or deactivate.

Aspect 15: A method of wireless communication performed by a network node, comprising: transmitting one or more channel state information (CSI)-reference signals (RSs); and receiving a compressed CSI report via layer 2 signaling, the compressed CSI report being compressed using a machine learning model.

Aspect 16: The method of Aspect 15, wherein the machine learning model comprises a first machine learning model, wherein the first machine learning model is associated with a second machine learning model at the network node, and wherein association of the second machine learning model to the first machine learning model supports reconstruction of the compressed CSI report.

Aspect 17: The method of any of Aspects 15-16, wherein the compressed CSI report comprises one or more of: an encoder output that indicates a precoder associated with the one or more CSI-RSs, a channel quality indicator (CQI), a rank index (RI), an indication of the machine learning model, or an indication of one or more CSI-RS occasions associated with the compressed CSI report.

Aspect 18: The method of Aspect 17, wherein the encoder output comprises a set of blocks of information, the set of blocks of information having a quantity that is based at least in part on a number of subbands and a number of layers associated with the one or more CSI-RSs, and wherein each block of the set of blocks of information is associated with a compressed precoder for one CSI subband on one layer.

Aspect 19: The method of Aspect 18, wherein the encoder output comprises the set of blocks ordered based at least in part on: a layer identifier, or a subband identifier.

Aspect 20: The method of Aspect 17, wherein one or more of the CQI or the RI is associated with an estimation of reconstruction of the compressed CSI report.

Aspect 21: The method of Aspect 17, wherein the CQI includes quality information for one or more of: a wideband frequency band, or subbands of the wideband frequency band.

Aspect 22: The method of Aspect 21, wherein a number of subbands of the wideband frequency band is less than or equal to a number of subbands indicated with the encoder output.

Aspect 23: The method of Aspect 17, wherein the indication of the machine learning model comprises an indication of the machine learning model from a set of candidate machine learning models.

Aspect 24: The method of Aspect 17, wherein the indication of one or more CSI-RS occasions associated with the compressed CSI report comprises one or more of: an indication of a slot and subframe number of a CSI-RS occasion associated with the compressed CSI report, or an indication of a slot and subframe number of a first CSI-RS occasion used to generate the compressed CSI report after CSI reports are activated.

Aspect 25: The method of any of Aspects 15-24, wherein the compressed CSI report is a periodic or semi-persistent compressed CSI report.

Aspect 26: The method of Aspect 25, wherein the compressed CSI report is activated based at least in part on activation or configuration of periodic or semi-persistent CSI-RSs.

Aspect 27: The method of Aspect 25, wherein the compressed CSI report is activated via an activation indication that is separate from an activation or configuration of periodic or semi-persistent CSI-RSs.

Aspect 28: The method of Aspect 27, wherein the activation indication indicates one or more layer 2 CSI reports to activate or deactivate.

Aspect 29: The method of any of Aspects 15-28, further comprising: reconstructing the compressed CSI report to produce a reconstruction of a precoder.

Aspect 30: An apparatus for wireless communication at a device, comprising a processor; memory coupled with the processor; and instructions stored in the memory and executable by the processor to cause the apparatus to perform the method of one or more of Aspects 1-29.

Aspect 31: A device for wireless communication, comprising a memory and one or more processors coupled to the memory, the one or more processors configured to perform the method of one or more of Aspects 1-29.

Aspect 32: An apparatus for wireless communication, comprising at least one means for performing the method of one or more of Aspects 1-29.

Aspect 33: A non-transitory computer-readable medium storing code for wireless communication, the code comprising instructions executable by a processor to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a +b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the team “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive one or more channel state information (CSI) reference signals (CSI-RSs); and
transmit a compressed CSI report via layer 2 signaling, the compressed CSI report being compressed using a machine learning model.

2. The UE of claim Error! Reference source not found., wherein the machine learning model comprises a first machine learning model,
wherein the machine learning model is associated with a second machine learning model at a network node, and
wherein association of the second machine learning model to the first machine learning model supports reconstruction of the compressed CSI report.

3. The UE of claim Error! Reference source not found., wherein the compressed CSI report comprises one or more of:
an encoder output that indicates a precoder associated with receiving the one or more CSI-RSs,
a channel quality indicator (CQI),
a rank index (RI),
an indication of the machine learning model, or
an indication of one or more CSI-RS occasions associated with the compressed CSI report.

4. The UE of claim Error! Reference source not found., wherein the encoder output comprises a set of blocks of information, the set of blocks of information having a quantity that is based at least in part on a number of subbands and a number of layers associated with the one or more CSI-RSs, and
wherein each block of the set of blocks of information is associated with a compressed precoder for one CSI subband on one layer.

5. The UE of claim Error! Reference source not found., wherein the encoder output comprises the set of blocks ordered based at least in part on:
a layer identifier, or
a subband identifier.

6. The UE of claim Error! Reference source not found., wherein one or more of the CQI or the RI is associated with an estimation of reconstruction of the compressed CSI report.

7. The UE of claim Error! Reference source not found., wherein the CQI includes quality information for one or more of:
a wideband frequency band, or
subbands of the wideband frequency band.

8. The UE of claim Error! Reference source not found., wherein a number of subbands of the wideband frequency band is less than or equal to a number of subbands indicated with the encoder output.

9. The UE of claim Error! Reference source not found., wherein the indication of the machine learning model comprises an indication of the machine learning model from a set of candidate machine learning models.

10. The UE of claim Error! Reference source not found., wherein the indication of one or more CSI-RS occasions associated with the compressed CSI report comprises one or more of:
an indication of a slot and subframe number of a CSI-RS occasion associated with the compressed CSI report, or
an indication of a slot and subframe number of a first CSI-RS occasion used to generate the compressed CSI report after CSI reports are activated.

11. The UE of claim Error! Reference source not found., wherein the compressed CSI report is a periodic or semi-persistent compressed CSI report.

12. The UE of claim Error! Reference source not found., wherein the compressed CSI report is activated based at least in part on activation or configuration of periodic or semi-persistent CSI-RSs.

13. The UE of claim Error! Reference source not found., wherein the compressed CSI report is activated via an activation indication that is separate from an activation or configuration of periodic or semi-persistent CSI-RSs.

14. The UE of claim Error! Reference source not found., wherein the activation indication indicates one or more layer 2 CSI reports to activate or deactivate.

15. A network node for wireless communication, comprising:
a memory; and
one or more processors, coupled to the memory, configured to:
transmit one or more channel state information (CSI) reference signals (CSI-RSs); and
receive a compressed CSI report via layer 2 signaling, the compressed CSI report being compressed using a machine learning model.

16. The network node of claim Error! Reference source not found., wherein the machine learning model is associated with an additional machine learning model at the network node, and
wherein association of the additional machine learning model to the machine learning model supports reconstruction of the compressed CSI report.

17. The network node of claim Error! Reference source not found., wherein the compressed CSI report comprises one or more of:
an encoder output that indicates a precoder associated with the one or more CSI-RSs,
a channel quality indicator (CQI),
a rank index (RI),
an indication of the machine learning model, or
an indication of one or more CSI-RS occasions associated with the compressed CSI report.

18. The network node of claim Error! Reference source not found., wherein the encoder output comprises a set of blocks of information, the set of blocks of information having a quantity that is based at least in part on a number of subbands and a number of layers associated with the one or more CSI-RSs, and
wherein each block of the set of blocks of information is associated with a compressed precoder for one CSI subband on one layer.

19. The network node of claim Error! Reference source not found., wherein the encoder output comprises the set of blocks ordered based at least in part on:
a layer identifier, or
a subband identifier.

20. The network node of claim Error! Reference source not found., wherein one or more of the CQI or the RI is associated with an estimation of reconstruction of the compressed CSI report.

21. The network node of claim Error! Reference source not found., wherein the CQI includes quality information for one or more of:
a wideband frequency band, or
subbands of the wideband frequency band.

22. The network node of claim Error! Reference source not found., wherein a number of subbands of the wideband frequency band is less than or equal to a number of subbands indicated with the encoder output.

23. The network node of claim Error! Reference source not found., wherein the indication of the machine learning model comprises an indication of the machine learning model from a set of candidate machine learning models.

24. The network node of claim Error! Reference source not found., wherein the indication of one or more CSI-RS occasions associated with the compressed CSI report comprises one or more of:
an indication of a slot and subframe number of a CSI-RS occasion associated with the compressed CSI report, or
an indication of a slot and subframe number of a first CSI-RS occasion used to generate the compressed CSI report after CSI reports are activated.

25. The network node of claim Error! Reference source not found., wherein the compressed CSI report is a periodic or semi-persistent compressed CSI report.

26. The network node of claim Error! Reference source not found., wherein the compressed CSI report is activated based at least in part on activation or configuration of periodic or semi-persistent CSI-RSs.

27. The network node of claim Error! Reference source not found., wherein the compressed CSI report is activated via an activation indication that is separate from an activation or configuration of periodic or semi-persistent CSI-RSs.

28. The network node of claim Error! Reference source not found., wherein the one or more processors are further configured to:
reconstruct the compressed CSI report to produce a reconstruction of a precoder.

29. A method of wireless communication performed by a user equipment (UE), comprising:
receiving one or more channel state information (CSI) reference signals (CSI-RSs); and
transmitting a compressed CSI report via layer 2 signaling, the compressed CSI report being compressed using a machine learning model.

30. A method of wireless communication performed by a network node, comprising:
transmitting one or more channel state information (CSI) reference signals (CSI-RSs); and
receiving a compressed CSI report via layer 2 signaling, the compressed CSI report being compressed using a machine learning model.
